(19) United States
(12) Patent Application Publication
(10) Pub. No.: US 2017/0315960 A1
(43) Pub. Date: Nov. 2, 2017

(54) FACTOR ANALYSIS APPARATUS, FACTOR ANALYSIS METHOD AND RECORDING MEDIUM, AND FACTOR ANALYSIS SYSTEM

(71) Applicant: NEC Corporation, Tokyo (JP)

(72) Inventor: Katsuhiro OCHIAI, Tokyo (JP)

(73) Assignee: NEC Corporation, Tokyo (JP)

(21) Appl. No.: 15/523,783

(22) PCT Filed: Nov. 16, 2015
(86) PCT No.: PCT/JP2015/005692

§ 371 Date: May 2, 2017

(30) Foreign Application Priority Data
Nov. 19, 2014 (JP) 2014-234619

(51) Int. Cl. G06F 17/17

(52) U.S. Cl. CPC G06F 17/17

(57) ABSTRACT

A factor analysis apparatus includes: an acquisition unit that acquires, from factor analysis data, time-series data of an objective variable representing a result of an event and time-series data of an explanatory variable representing a factor of an event; a criterion-value setting unit that sets, based on the time-series data of the objective variable, a plurality of objective-variable criterion values; an influence degree calculation unit that learns the set plurality of objective-variable criterion values and the acquired time-series data of the explanatory variable, generates a relational expression between the objective-variable criterion value and the explanatory variable for each of the objective-variable criterion values, and extracts, from the generated relational expression, a coefficient of the explanatory variable and the explanatory variable corresponding to the coefficient; and an output unit that outputs the extracted coefficient as an influence degree, and outputs an explanatory variable name associated with the extracted explanatory variable.

### TECHNICAL FIELD

The present invention relates to a factor identification apparatus and the like.

### BACKGROUND ART

A statistical approach using regression analysis is widely used in quality management of a manufacturing process, as a technique for elucidating a relationship between an objective variable that represents a result of an event and an explanatory variable that represents a factor of an event and specifying an explanatory variable that strongly influences a value of an objective variable. Many analysis approaches typified by the regression analysis are a method of acquiring measurement data from a measuring instrument such as a sensor and multidimensionally analyzing the acquired measurement data.

PTL 1 describes an approach of splitting, based on nominal scale data included in an explanatory variable, the nominal scale data into segments and specifying an influence factor by using a multivariate analysis approach for each of the segments.

PTL 2 describes that a plurality of explanatory variables are divided into groups, linear multiple regression analysis is executed for each of the divided groups to narrow down the explanatory variables, and a cause of quality fluctuation in a manufacturing line is analyzed by repeating the narrowing-down operation.

In addition, NPL 1 describes that, when an objective variable is a discrete value, a degree of influence by an explanatory variable is estimated with high precision by using L1 regularized logistic regression.

NPL 2 describes a random forest classifier that is a classifier constructed using a plurality of decision trees.

### CITATION LIST

### Patent Literature

[PTL 1] Japanese Unexamined Patent Application Publication No. 2009-258890
[PTL 2] Japanese Unexamined Patent Application Publication No. 2002-110493
[PTL 3] Japanese Unexamined Patent Application Publication No. 2008-117381
[PTL 4] Japanese Unexamined Patent Application Publication No. 2000-315111

### Non Patent Literature

[NPL 1] Andrew Y. Ng, “Feature selection, L1 vs. L2 regularization, and rotational invariance” in Proceedings of the 21st International Conference of Machine Learning, pp. 78-85, 2004, ISBN: 1-58113-838-5
[NPL 2] Breiman. L, “Random Forests”, Machine Learning, Vol. 45, No. 1, pp. 5-32, 2001, ISSN: 0885-6125

### SUMMARY OF INVENTION

### Technical Problem

FIG. 15 is a diagram describing an example of obtaining, by learning, a classification model representing a relationship between an objective variable that represents a result of an event and an explanatory variable that represents a factor of an event. As illustrated in FIG. 15, a learning device learns by using explanatory variables (X₁, X₂, . . . , Xₙ) (n is a natural number) and an objective variable (boundary condition: Y≧4, criterion values Y={1, 2, 3, 4, 5}) as inputs. Thus, a classification model representing a relationship between the objective variable (Y) and the explanatory variables (any of X₁ to Xₙ) is generated. In FIG. 15, the objective variable (Y) uses a boundary condition such as product quality. A boundary condition, i.e. Y≧4, means that a criterion value of allowable quality is “4” or more among criterion values “1” to “5” of predetermined quality. The explanatory variables (X₁, X₂, . . . , Xₙ) are assigned with values relating to manufacture of a product, such as a heating temperature and a heating time, for example. An analyzer obtains a coefficient α (any of α₁ to αₙ (n is a natural number)) of the explanatory variable (X) by means of the analysis approach of PTL 1, or PTL 2 or NPL 1 or NPL 2 in such a manner that the objective variable (in this case, Y≧4) can be explained for “Y=α₁·X₁+α₂·X₂+ . . . +aₙ·Xₙ” which represents the classification model.

However, when there are a plurality of fluctuation factors of an objective function (for example, quality fluctuation factors) and the fluctuation factors vary in stages having dependency on one another, the above-described analysis allows an analyzer to know only a fluctuation factor at a final stage satisfying a boundary condition. In other words, the above-described analysis does not allow for knowing a stepwise fluctuation factor leading to the final-stage fluctuation factor, or a fluctuation factor at an early stage.

An object of the present invention is to provide a technique capable of elucidating transition of a fluctuation factor of an objective variable.

### Solution to Problem

A factor analysis apparatus includes: acquisition means that acquires, from factor analysis data, time-series data of an objective variable representing a result of an event and time-series data of an explanatory variable representing a factor of an event; criterion-value setting means that sets, based on the time-series data of the objective variable, a plurality of objective-variable criterion values; influence degree calculation means that learns the set plurality of objective-variable criterion values and the acquired time-series data of the explanatory variable, generates a relational expression between the objective-variable criterion value and the explanatory variable for each of the objective-variable criterion values, and extracts, from the generated relational expression, a coefficient of the explanatory variable and the explanatory variable corresponding to the coefficient; and output means that outputs the extracted coefficient as an influence degree, and outputs an explanatory variable name associated with the extracted explanatory variable.

A factor analysis system includes the factor analysis apparatus, a measurement object apparatus that is to be measured by a measuring instrument and a management apparatus that collects measurement data measured by the measuring instrument and sends the measurement data as time-series data to the factor analysis apparatus.

A factor analysis method includes: acquiring, from factor analysis data, time-series data of an objective variable representing a result of an event and time-series data of an explanatory variable representing a factor of an event; setting, based on the time-series data of the objective variable, a plurality of objective-variable criterion values; learning the set plurality of objective-variable criterion values and the acquired time-series data of the explanatory variable, and generating a relational expression between the objective-variable criterion value and the explanatory variable for each of the objective-variable criterion values; extracting, from the generated relational expression, a coefficient of the explanatory variable and the explanatory variable corresponding to the coefficient; and outputting the extracted coefficient as an influence degree, and outputting an explanatory variable name associated with the extracted explanatory variable.

A recording medium recording a program that causes a computer to execute: acquiring, from factor analysis data, time-series data of an objective variable representing a result of an event and time-series data of an explanatory variable representing a factor of an event; setting, based on the time-series data of the objective variable, a plurality of objective-variable criterion values; learning the set plurality of objective-variable criterion values and the acquired time-series data of the explanatory variable, and generating a relational expression between the objective-variable criterion value and the explanatory variable for each of the objective-variable criterion values; extracting, from the generated relational expression, a coefficient of the explanatory variable and the explanatory variable corresponding to the coefficient; and outputting the extracted coefficient as an influence degree, and outputting an explanatory variable name associated with the extracted explanatory variable.

### Advantageous Effects of Invention

According to the present invention, transition of a fluctuation factor of an objective variable can be elucidated.

### BRIEF DESCRIPTION OF DRAWINGS

FIG. 1 is a diagram describing an example of creating a plurality of classifications given by explanatory variables from a set of the explanatory variables and an objective variable (a plurality of criterion values);

FIG. 2 is a block diagram illustrating a configuration of a factor analysis apparatus according to a first example embodiment;

FIG. 3 is a flowchart illustrating an operation of the factor analysis apparatus according to the first example embodiment;

FIG. 4 is a flowchart for describing a method of computation for reducing an amount of computation of the factor analysis apparatus according to the first example embodiment;

FIG. 5 is a block diagram illustrating a configuration of a factor analysis system according to a second example embodiment;

FIG. 6 is a schematic diagram illustrating a configuration of a chemical plant in the factor analysis system;

FIG. 7 is a data sheet showing measurement data accepted from a sensor group of the chemical plant;

FIG. 8 is a block diagram illustrating a configuration of a factor analysis apparatus according to the second example embodiment;

FIG. 9 is a flowchart illustrating an operation of the factor analysis system according to the second example embodiment;

FIG. 10 is a flowchart illustrating an operation of the factor analysis apparatus according to the second example embodiment;

FIG. 11 is a first data sheet showing influence degrees obtained by the factor analysis apparatus and explanatory variable names;

FIG. 12 is a second data sheet showing influence degrees obtained by the factor analysis apparatus and explanatory variable names;

FIG. 13 is a third data sheet showing influence degrees obtained by the factor analysis apparatus and explanatory variable names;

FIG. 14 is a block diagram illustrating a hardware configuration that implements the factor analysis apparatus according to the first example embodiment and the factor analysis apparatus and a management apparatus according to the second example embodiment by a computer device; and

FIG. 15 is a diagram describing an example of creating a classification model given by explanatory variables from a set of the explanatory variables and an objective variable.

### DESCRIPTION OF EMBODIMENTS

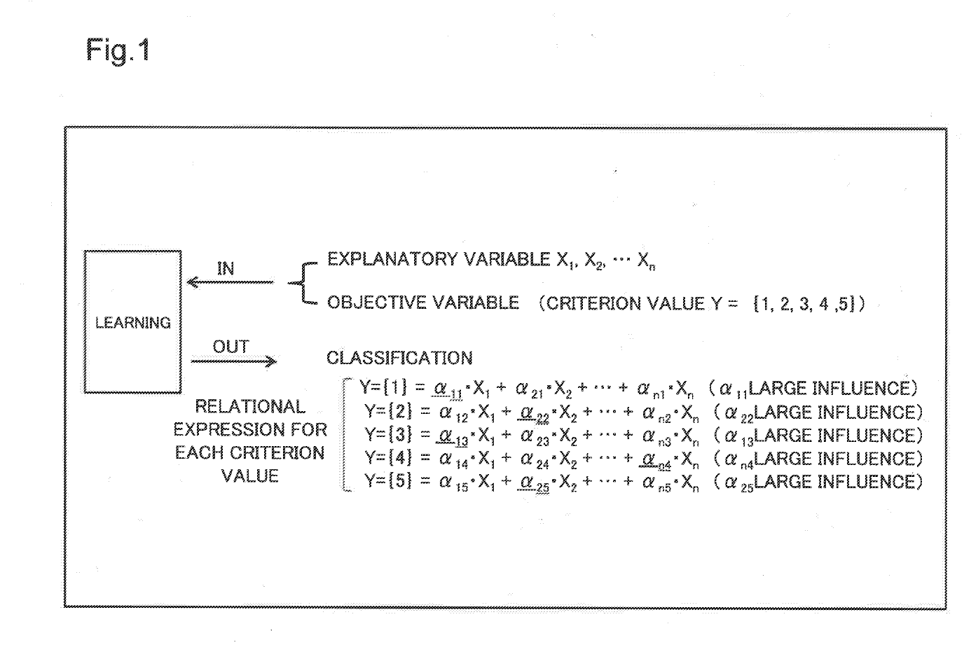

First, a factor analysis approach for use in a factor analysis apparatus according to each of example embodiments herein will be described with use of the drawings. FIG. 1 is a diagram describing an example of creating classifications given by explanatory variables from a set of the explanatory variables and an objective variable (a plurality of criterion values). In order to stepwisely capture an influence of each explanatory variable (X₁, X₂, . . . , Xₙ) (n is a natural number) imposed on an objective variable Y, the factor analysis apparatus according to each of the example embodiments uses criterion values as an objective variable instead of a boundary condition. In other words, by learning a set of explanatory variables and a plurality of criterion values of an objective variable, a relational expression (classification) between the objective variable and the explanatory variable is generated for each of the criterion values of the objective variable. In the generation, as illustrated in FIG. 1, a coefficient α of the explanatory variable in the relational expression fluctuates for each of the criterion values of the objective variable. This results in different explanatory variables influencing the criterion values of the objective variable. Accordingly, this allows for stepwisely knowing a factor (explanatory variable) that influences the criterion value of the objective variable and an influence degree (coefficient α) that represents a degree of the influence, from a process of the fluctuation of the coefficient α in the relational expression. Note that the relational expressions (classifications) illustrated in FIG. 1 will be described later in detail.

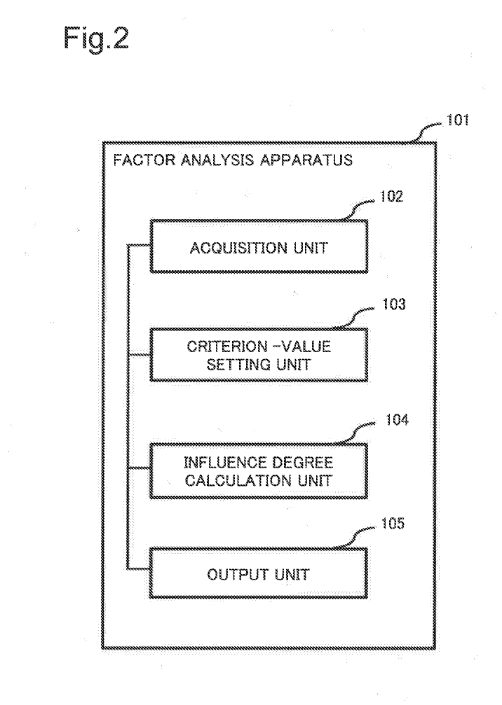

Next, a factor analysis apparatus according to a first example embodiment will be described with reference to the drawings. FIG. 2 is a block diagram illustrating a configuration of the factor analysis apparatus according to the first example embodiment.

A factor analysis apparatus 101 includes an acquisition unit 102, a criterion-value setting unit 103, an influence degree calculation unit 104, and an output unit 105.

The acquisition unit 102 accepts factor analysis data and stores, among the factor analysis data, time-series data of an objective variable representing a result of an event as objective-variable time-series data in a storage unit (not illustrated). In addition, the acquisition unit 102 stores time-series data of an explanatory variable representing a factor of an event as explanatory-variable time-series data in the storage unit. Note that the acquisition unit 102 may send the objective-variable time-series data or the explanatory-variable time-series data to the influence degree calculation unit 104 without storing in the storage unit.

The explanatory variable may use, for example, data representing an operating condition of a system, such as an adjustment value, a temperature, a pressure, a gas flow rate, and a voltage of an apparatus. The objective variable may use, for example, data representing an evaluation index, such as quality or yield of a product. The time-series data indicates data arranged in order of time at a predetermined time interval.

Note that the factor analysis data may be measurement data measured by a measuring instrument, and may be log data generated by an arbitrary system. In addition, the factor analysis data may be input data input via an input device (not illustrated) such as a keyboard.

The acquisition unit 102 may accept the factor analysis data from the outside via communication or a medium. In addition, the factor analysis apparatus 101 may have a function of including a function of generating or storing the factor analysis data.

The criterion-value setting unit 103 sets criterion values of an objective variable (objective-variable criterion values), based on objective-variable time-series data.

The objective-variable criterion values may be set to a range of arbitrary objective-variable criterion values for which a factor of an event is desired to know. The range may be a range between the minimum value and the maximum value that the objective-variable time-series data can take, or may be a part of the range. For the part of the range, for example, some kind of a criterion such as “a range of ⅕ to ⅘” or a statistical amount such as within some % is used. The range of the objective-variable criterion values is determined in the factor analysis apparatus 101, or by an external apparatus.

The objective-variable criterion values may be set to any values as long as arbitrary discrete values maintain continuity with a predetermined interval. Note that when a process of factor analysis is desired to know in further detail, granularity of the discrete values is set small. In addition, when a process of factor analysis is desired to know more roughly, granularity of the discrete values is set large. The granularity may be determined in an apparatus other than the factor analysis apparatus 101 and a result of the determination is set in the criterion-value setting unit 103. In addition, in a case of determining the granularity in the factor analysis apparatus 101, the criterion values may be determined with a criterion, such as a particular number or values of some percent basis, and may be determined by a statistical amount. In addition, the objective-variable criterion values may be integers, and may be real numbers.

The criterion-value setting unit 103 sends the set objective-variable criterion values to the influence degree calculation unit 104. Note that the criterion-value setting unit 103 may store the objective-variable criterion values temporarily in the storage unit instead of sending to the influence degree calculation unit 104. In the case, the influence degree calculation unit 104 acquires the objective-variable criterion values from the storage unit as needed.

Next, the influence degree calculation unit 104 learns by using objective-variable criterion values and explanatory-variable time-series data, and creates a relational expression (classification) given by coefficients α and explanatory variables for each of the objective-variable criterion values. The learning method may be any learning method available for classification. For example, L1 regularized logistic regression, a decision tree, non-linear regression, or similar approaches thereof may be used.

The created classification will be described with use of the example illustrated in FIG. 1. The classifications illustrated in FIG. 1 are relational expressions explaining the respective objective-variable criterion values Y={1, 2, 3, 4, 5} by using the explanatory variables (X₁, X₂, . . . , Xₙ) (n is a natural number).

Y={1}=α₁₁·X₁+α₂₁·X₂+ . . . +αₙ₁·Xₙ

(α₁₁ is the maximum value among α₁₁, α₂₁, . . . , αₙ₁)

Y={2}=α₁₂·X₁+α₂₂·X₂+ . . . +αₙ₂·Xₙ

(α₂₂ is the maximum value among α₁₂, α₂₂, . . . , αₙ₂)

Y={3}=α₁₃·X₁+α₂₃·X₂+ . . . +αₙ₃·Xₙ

(α₁₃ is the maximum value among α₁₃, α₂₃, . . . , αₙ₃)

Y={4}=α₁₄·X₁+α₂₄·X₂+ . . . +αₙ₄·Xₙ

(αₙ₄ is the maximum value among α₁₄, α₂₄, . . . , αₙ₄)

Y={5}=α₁₅·X₁+α₂₅·X₂+ . . . +αₙ₅·Xₙ

(α₂₅ is the maximum value among α₁₅, α₂₅, . . . , αₙ₅)

The influence degree calculation unit 104 extracts, from each of the generated relational expressions (classifications), a coefficient (for example, α₁₁, α₂₁, . . . , αₙ₁ when the objective-variable criterion value Y={1}) of the explanatory variable and the explanatory variable (for example, X₁) corresponding to the coefficient for each of the objective-variable criterion values (any of X₁ to Xₙ).

The influence degree calculation unit 104 is able to select an explanatory variable that largely influences an objective-variable criterion value and a coefficient α that indicates an influence degree representing a degree of the influence by extracting a coefficient α being the maximum value in the relational expression of classification and extracting a corresponding explanatory variable. In the example of FIG. 1,

explanatory variable X₁ of coefficient α₁₁ is selected when the objective-variable criterion value Y={1},
explanatory variable X₂ of coefficient α₂₂ is selected when the objective-variable criterion value Y={2},
explanatory variable X₁ of coefficient α₁₃ is selected when the objective-variable criterion value Y={3},
explanatory variable Xₙ of coefficient αₙ₄ is selected when the objective-variable criterion value Y={4}, and
explanatory variable X₂ of coefficient α₂₅ is selected when the objective-variable criterion value Y={5}.

The influence degree calculation unit 104 stores, for each of the objective-variable criterion values, the selected influence degree (for example, α₁₁) and the explanatory variable (for example, X₁) associated with the influence degree as influence degree transition data in the storage unit. Alternatively, the influence degree calculation unit 104 sends the influence degree transition data to the output unit 105 at the next stage.

The output unit 105 has a function of outputting the acquired influence degree transition data to a display device (not illustrated). Note that the factor analysis apparatus 101 may include the display device. In addition, the output unit 105 may include a function of outputting the data to the outside of the factor analysis apparatus 101 via a communication unit (not illustrated) or a medium recording unit (not illustrated).

The output unit 105 may output an explanatory variable name in influence degree order, and may output an explanatory variable name influencing a part or all of a series of process. The influence degree order is, for example, descending order of value of an influence degree. In addition, the order is not limited to the influence degree order, but may be order of the explanatory variable name, order of arrangement of explanatory variables, or order of leading time of time-series data included in the explanatory variables. The explanatory variable name is an identification name assigned for each explanatory variable and is represented as, for example, motor rotation speed.

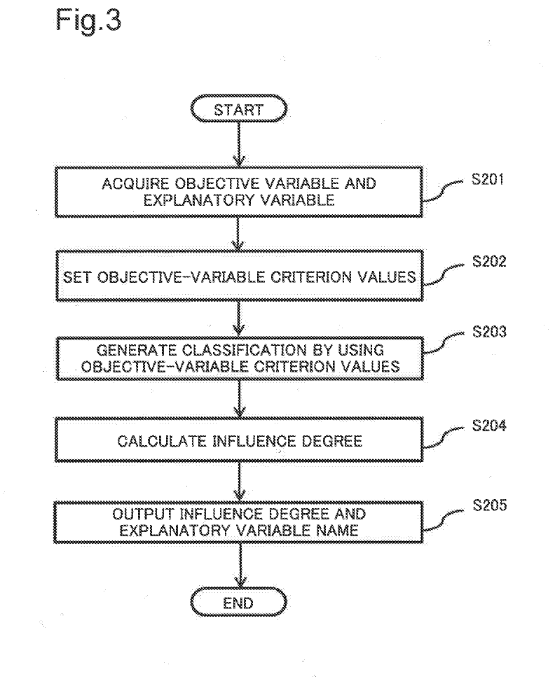

FIG. 3 is a flowchart illustrating an operation of the factor analysis apparatus according to the first example embodiment.

The acquisition unit 102 acquires, among accepted factor analysis data, time-series data representing a result of an event as objective-variable time-series data, and acquires time-series data representing a factor of an event as explanatory-variable time-series data (S201). The acquisition unit 102 may store the objective-variable time-series data and the explanatory-variable time-series data in the storage unit, and may send the objective-variable time-series data and the explanatory-variable time-series data to the influence degree calculation unit 104.

The criterion-value setting unit 103 sets objective-variable criterion values, based on the acquired objective-variable time-series data (S202). The criterion-value setting unit 103 sends the set objective-variable criterion values to the influence degree calculation unit 104. Note that the criterion-value setting unit 103 may store the objective-variable criterion values temporarily in the storage unit instead of sending to the influence degree calculation unit 104. In the case, the influence degree calculation unit 104 acquires the objective-variable criterion values from the storage unit as needed.

The influence degree calculation unit 104 learns by using a set of the set objective-variable criterion values and the explanatory-variable time-series data, and generates a relational expression (classification) given by coefficients α and explanatory variables (S203). Subsequently, the influence degree calculation unit 104 extracts, from the generated relational expression (classification), a coefficient α (for example, α₁₁, α₂₁, . . . , αₙ₁) of the explanatory variable and the explanatory variable (X₁, X₂, . . . , Xₙ) corresponding to the coefficient for each of the objective-variable criterion values (S204). The influence degree calculation unit 104 stores the coefficient α of the explanatory variable as an influence degree and the explanatory variable associated with the influence degree as influence degree transition data in the storage unit. Alternatively, the influence degree calculation unit 104 sends the influence degree transition data to the output unit 105 at the next stage.

The output unit 105 acquires the influence degree transition data, and outputs the influence degree and an explanatory variable name for each of the objective-variable criterion values (S205).

### Modification Example of First Example Embodiment

The above first example embodiment has shown an example in which explanatory-variable time-series data, objective-variable time-series data, and influence degree transition data are stored in the storage unit of the factor analysis apparatus 101. However, the first example embodiment is not limited thereto. For example, a configuration may be employed in which explanatory-variable time-series data, objective-variable time-series data, and influence degree transition data to be stored in the storage unit are stored in a storage device connected with the factor analysis apparatus 101.

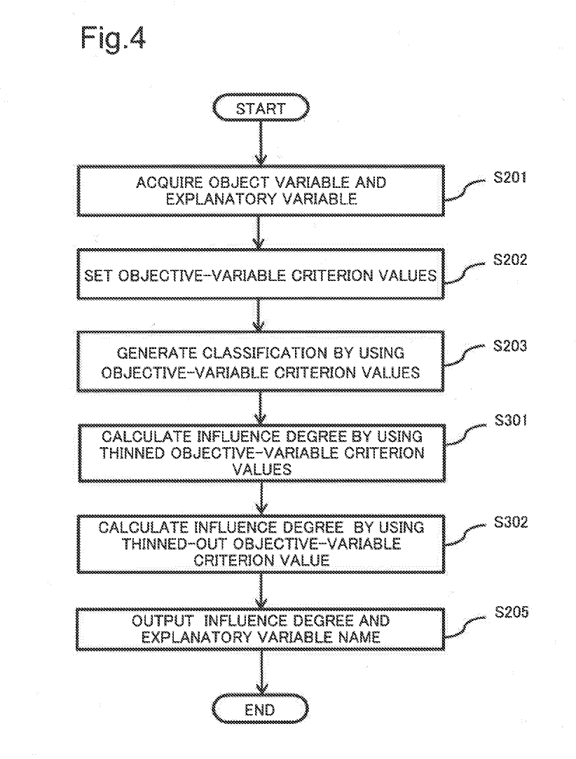

The operation of the influence degree calculation unit 104 of the factor analysis apparatus 101 requires a large amount of computation time depending on an amount of data. FIG. 4 is a flowchart describing a method of computation for reducing an amount of computation of the factor analysis apparatus according to the first example embodiment. As illustrated in FIG. 4, steps from S201 at which an objective variable and explanatory variables are acquired to S203 at which classifications are generated by using objective-variable criterion values, and a step of S205 at which an influence degree and an explanatory variable name are output are the same as those in the flowchart of FIG. 3, and thus, description thereof will be omitted.

After generating a classification (relational expression) for each of the objective-variable criterion values, the influence degree calculation unit 104 computes an influence degree with coarse granularity set for the objective-variable criterion values. In other words, the influence degree calculation unit 104 calculates an influence degree by using thinned objective-variable criterion values (S301). For example, the influence degree calculation unit 104 calculates an influence degree by using objective-variable criterion values “4” and “2” obtained by thinning out an objective-variable criterion value “3” from the objective-variable criterion values “4”, “3” and “2” that are set as the objective-variable criterion values. Next, the influence degree calculation unit 104 extracts an explanatory variable having a low influence degree from the relational expressions of the objective-variable criterion values “4” and “2”, and when calculating an influence degree of the thinned-out objective-variable criterion value “3”, eliminates in advance the explanatory variable having a low influence degree and calculates an influence degree (S302). This enables reduction in an amount of computation of the influence degree calculation unit 104. Note that the influence degree calculation unit 104 may extract an explanatory variable having a high influence degree from the relational expressions of the objective-variable criterion values “4” and “2”, and may calculate an influence degree of the thinned-out objective-variable criterion value “3” by using only the explanatory variable having a high influence degree.

As described above, in the factor analysis apparatus according to the first example embodiment, the influence degree calculation unit 104 learns by using a set of the set objective-variable criterion values and explanatory-variable time-series data, and generates a relational expression (classification) given by coefficients α and explanatory variables for each of the objective-variable criterion values. Subsequently, the influence degree calculation unit 104 extracts, from the generated relational expression (classification), a coefficient of the explanatory variable and the explanatory variable corresponding to the coefficient in association with each other. Accordingly, this allows for knowing a fluctuation process of the coefficient for each of the objective-variable criterion values and knowing an explanatory variable that influences an objective variable. This can elucidate transition of a fluctuation factor of the objective variable.

### Second Example Embodiment

Next, a factor analysis system according to a second example embodiment will be described with use of the drawings. The factor analysis system according to the second example embodiment is an example in which the factor analysis apparatus according to the first example embodiment is applied to factor analysis for product quality of a chemical plant.

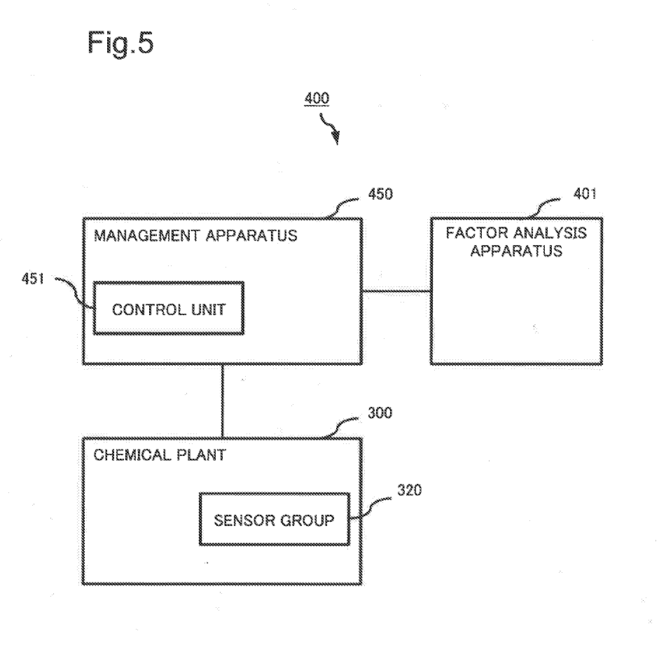

FIG. 5 is a block diagram illustrating a configuration of the factor analysis system according to the second example embodiment. According to FIG. 5, a factor analysis system 400 includes a chemical plant 300, a management apparatus 450, and a factor analysis apparatus 401. The chemical plant 300 is connected with the factor analysis apparatus 401 via the management apparatus 450. In addition, the factor analysis apparatus 401 is connected with a storage device (not illustrated).

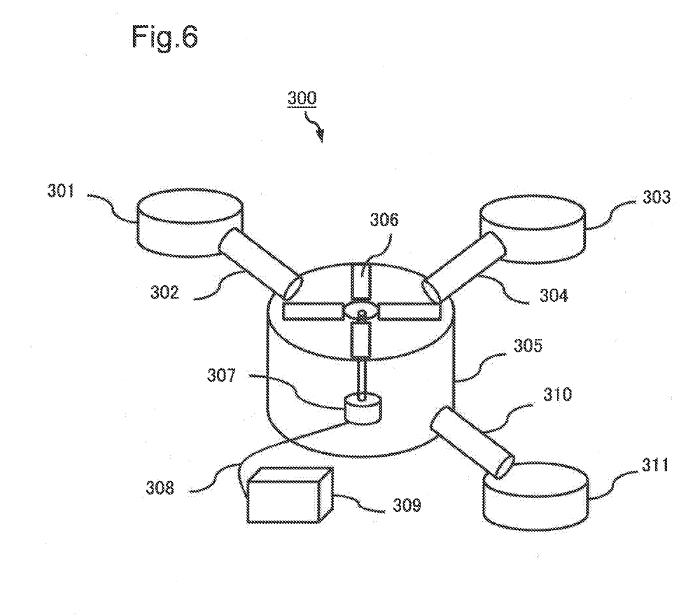

The chemical plant 300 according to the second example embodiment is a manufacturing apparatus for manufacturing a homogeneous material product by adequately stirring input raw material A and raw material B. FIG. 6 is a block diagram illustrating a configuration of the chemical plant 300.

In the chemical plant 300, a feeding tank 301 for raw material A has a function of feeding raw material A in the feeding tank 301 for raw material A to a stirring tank 305 via a pipe 302 for raw material A. In addition, a feeding tank 303 for raw material B has a function of feeding raw material B in the feeding tank 303 for raw material B to the stirring tank 305 via a pipe 304 for raw material B.

The stirring tank 305 has installed therein a motor 307 and a stirring propeller 306 driven by the motor 307, and has a function of stirring a group of raw materials input into the tank. The motor 307 is supplied with electric power from a power supply 309 via a power cord 308. The stirring tank 305 feeds a stirred material product to a product tank 311 via a pipe 310 for product.

The respective components of the chemical plant 300 are attached with various sensors. Specifically, the feeding tank 301 for raw material A has a sensor for measuring a type of raw material A and a quantity of input raw material A. The feeding tank 303 for raw material B has a sensor for measuring a type of raw material B and a quantity of input raw material B. The pipe 302 for raw material A has a sensor for measuring a flow rate of the pipe for raw material A. The pipe 304 for raw material B has a sensor for measuring a flow rate of the pipe for raw material B. The pipe 310 for product has a sensor for measuring a flow rate of the pipe for product. The motor 307 has a sensor for measuring a rotation speed of the motor. The stirring tank 305 has a sensor for measuring a temperature of the stirring tank and a water level of the stirring tank. The product tank 311 has a sensor for measuring a water level of the product tank and product quality.

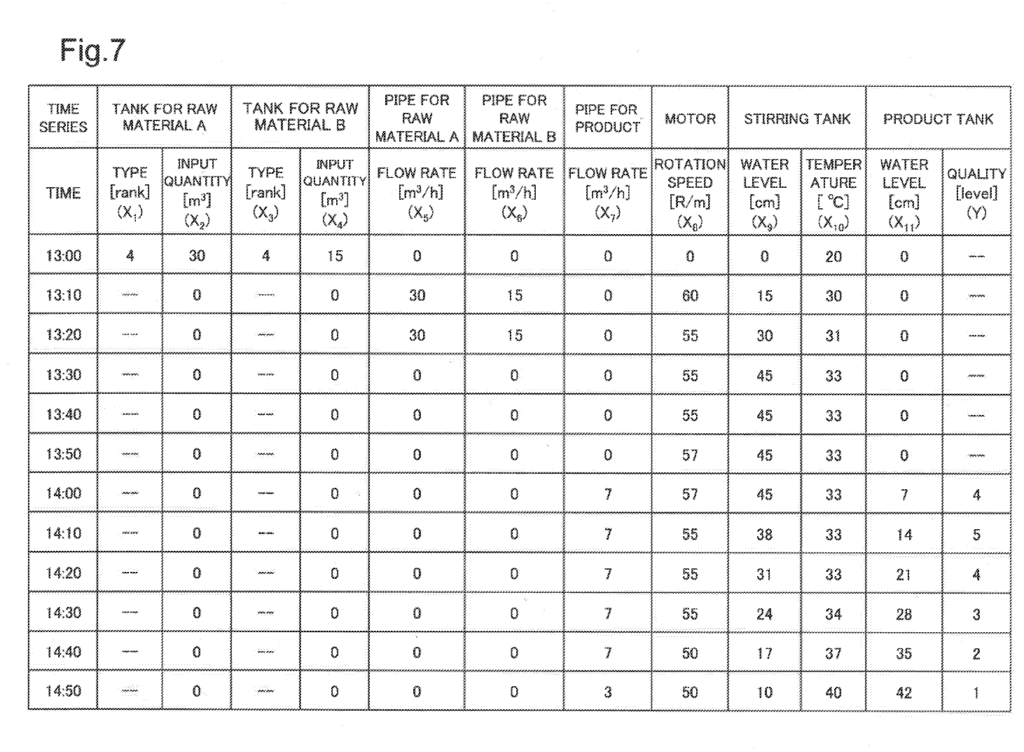

The management apparatus 450 includes a control unit 451. The control unit 451 has a function of storing measurement data measured at a sensor group 320 of the chemical plant 300 in a storage unit (not illustrated) and sending the measurement data as predetermined time-series data to the factor analysis apparatus 401. FIG. 7 is a data sheet showing an example of measurement data accepted by the management apparatus 450 from the sensor group 320 of the chemical plant 300. The management apparatus 450 transmits measurement data to the factor analysis apparatus 401 via a communication unit (not illustrated). Alternatively, the management apparatus 450 may store measurement data in a detachable non-volatile memory (for example, a Universal Serial Bus (USB) memory), and may provide the measurement data to the factor analysis apparatus 401 to be described later via the USB memory.

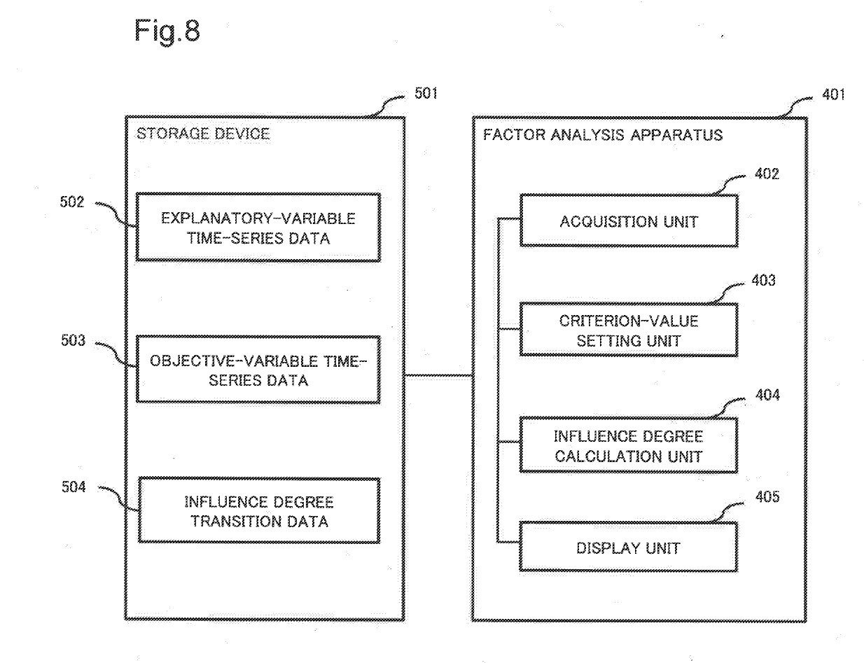

FIG. 8 is a block diagram illustrating a configuration of the factor analysis apparatus according to the second example embodiment. The factor analysis apparatus 401 is connected with a storage device 501. The configuration of the factor analysis apparatus 401 according to the second example embodiment is the same as those of the factor analysis apparatus 101 according to the first example embodiment except for a display unit 405. In other words, an acquisition unit 402, a criterion-value setting unit 403, and an influence degree calculation unit 404 of the factor analysis apparatus 401 according to the second example embodiment respectively have functions similar to those of the acquisition unit 102, the criterion-value setting unit 103, and the influence degree calculation unit 104 of the factor analysis apparatus 101 according to the first example embodiment. Note that the display unit 405 of the factor analysis apparatus 401 according to the second example embodiment has a configuration specialized for displaying data within the function of the output unit 105 of the factor analysis apparatus 101 according to the first example embodiment. In addition, the storage device 501 according to the second example embodiment has a function similar to that of the storage device 201 according to the first example embodiment. Thus, detailed description about the configuration of the factor analysis apparatus 401 will be omitted.

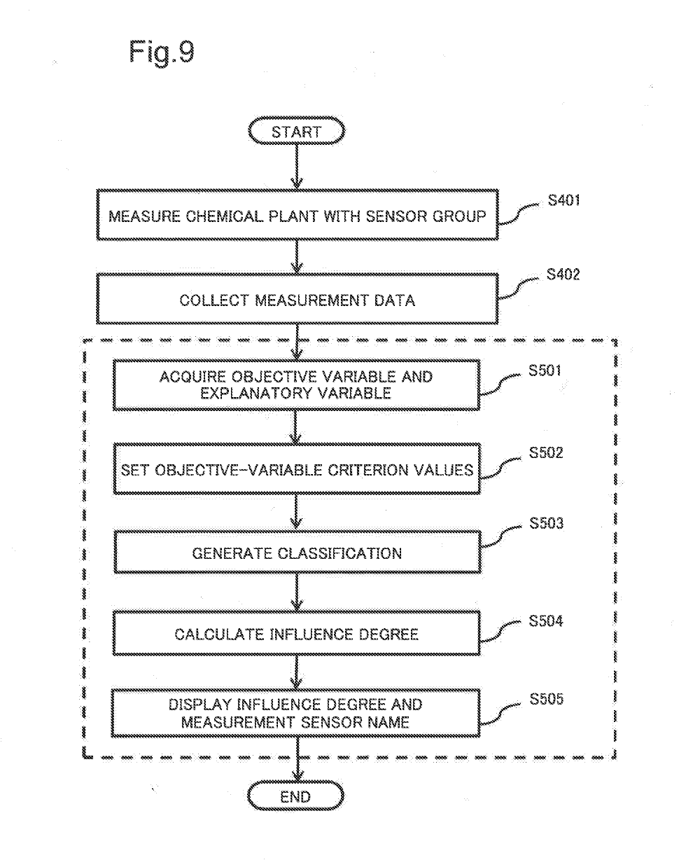

FIG. 9 is a flowchart illustrating an operation of the factor analysis system according to the second example embodiment.

First, the set sensor group 320 of the chemical plant 300 measures the chemical plant 300 at a predetermined time interval (S401), and sends the measured measurement data to the management apparatus 450. Next, the management apparatus 450 collects the measurement data (S402), and sends the measurement data as factor analysis data to the factor analysis apparatus 401.

A dashed line of FIG. 9 is a flowchart illustrating an operation of the factor analysis apparatus 401. The operation of the factor analysis apparatus 401 is the same as that of the factor analysis apparatus 101 according to the first example embodiment except for a step S505. In other words, steps S501 to S504 illustrating the operation of the factor analysis apparatus 401 are the same as the steps S201 to S204 illustrating the operation of the factor analysis apparatus 101 according to the first example embodiment. In addition, the step S505 of the factor analysis apparatus 401 is different in that an explanatory variable name is replaced by a measurement sensor name and output is replaced by display.

First, the acquisition unit 402 of the factor analysis apparatus 401 accepts the factor analysis data of the chemical plant 300 from the management apparatus 450. Further, the acquisition unit 402 acquires, among the factor analysis data, time-series data of product quality (hereinafter, referred to as quality data) as objective-variable time-series data 503, and acquires time-series data other than the product quality (hereinafter, referred to as factor data) as explanatory-variable time-series data 502 (S501). The acquisition unit 402 stores the quality data (objective-variable time-series data 503) and the factor data (explanatory-variable time-series data 502) in the storage device 501, or sends the quality data and the factor data to the influence degree calculation unit 404.

The criterion-value setting unit 403 acquires the quality data from the acquisition unit 402, and sets objective-variable criterion values of the product quality, based on the quality data (S502). Herein, a range of the quality data is from “1” to “5”, where objective-variable criterion value “1” indicates the best quality and objective-variable criterion value “5” indicates the worst quality. Objective-variable criterion values “4” and “5” are defined as defective products for the product quality, and the objective-variable criterion values set at step S503 are in a range of objective-variable criterion values “2” to “4”. In addition, granularity of the objective-variable criterion values is “1”. The criterion-value setting unit 403 sends the set objective-variable criterion values to the influence degree calculation unit 404.

The influence degree calculation unit 404 learns the factor data and the objective-variable criterion values of the quality data by using L1 regularized logistic regression, and generates a relational expression (classification) given by coefficients α and explanatory variables for each of the objective-variable criterion values (S503). Subsequently, the influence degree calculation unit 404 extracts, from the generated relational expression (classification), a coefficient of the explanatory variable and the explanatory variable corresponding to the coefficient in association with each other (S504). The influence degree calculation unit 404 sends the coefficient α of the explanatory variable as an influence degree, and the explanatory variable associated with the influence degree as influence degree transition data 504 to the display unit 405.

The display unit 405 displays, from the influence degree transition data 504, the influence degree analyzed via the above-described process and a measurement sensor name corresponding to an explanatory variable name together with the objective-variable criterion values (S505).

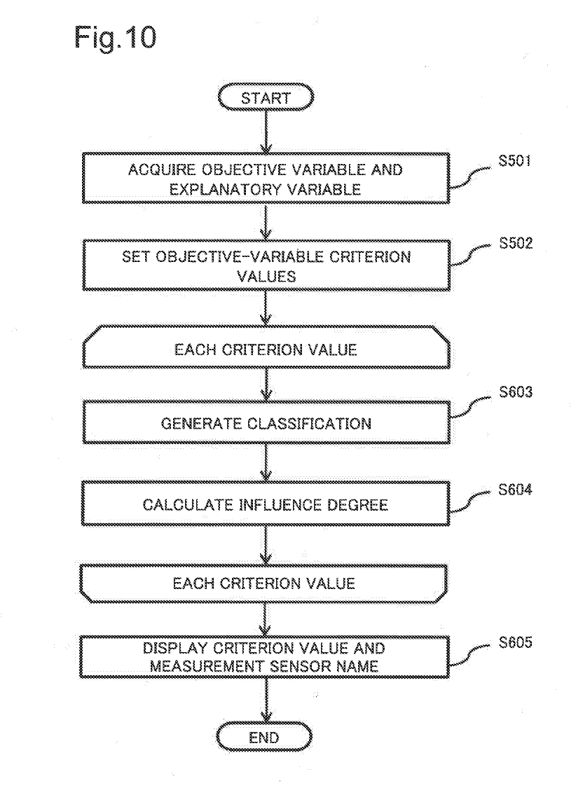

Note that the operation of the factor analysis apparatus 401 according to the above-described second example embodiment is not limited to the above, but another operation can also obtain an influence degree. FIG. 10 is a flowchart illustrating another operation of the factor analysis apparatus according to the second example embodiment. The operation of the factor analysis apparatus 401 illustrated in FIG. 9 is an operation of generating all classifications for the respective set objective-variable criterion values and calculating influence degrees from the generated classifications. In contrast to this, in the operation of the factor analysis apparatus 401 illustrated in FIG. 10, first, a classification is created for one of the set objective-variable criterion values (S603), and subsequently, an influence degree of the generated one relational expression (classification) is calculated (S604). Next, a classification is generated by using another one of the objective-variable criterion values (S603), and subsequently, an influence degree of the generated one relational expression (classification) is calculated (S604).

The factor analysis apparatus illustrated in FIG. 10 repeats this loop for the set objective-variable criterion values. For example, a processing loop starts with the objective-variable criterion value “4” for the first time, and the objective-variable criterion value is reset to be decremented by a granularity of “1” every time the processing loop is completed. Next, the influence degree calculation unit 404 calculates an influence degree of the objective-variable criterion value set at the criterion-value setting unit 403, and stores the criterion value and the influence degree as the influence degree transition data 504. The processing from S603 to S604 is repeated to a product quality criterion value “2” that satisfies a setting range of the criterion values determined at the criterion-value setting unit 403. When calculation of an influence degree is completed for criterion values “2”, “3” and “4” within the setting range, the objective-variable criterion values of the quality data and a measurement sensor name corresponding to an explanatory variable name influencing the quality data are displayed in order of influence on the display unit 405 (S605).

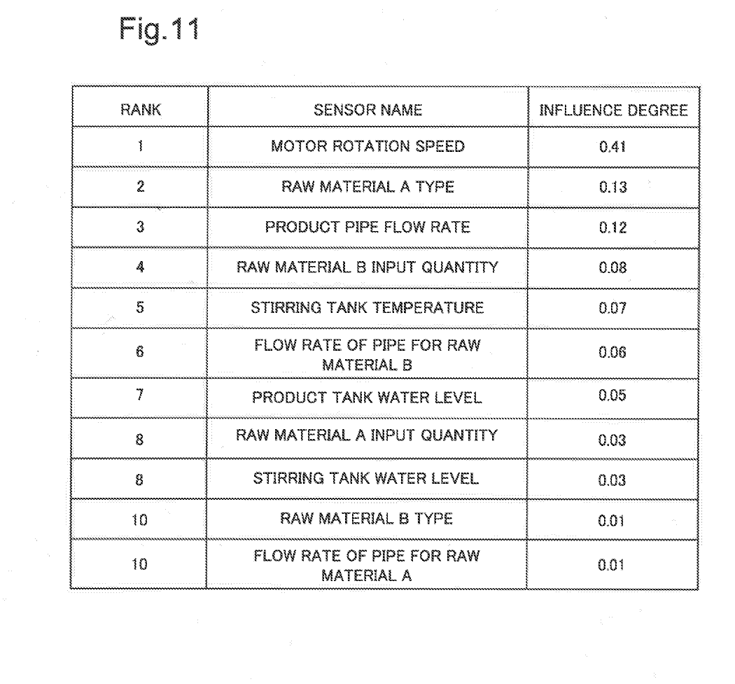

FIGS. 11, 12, and 13 are first, second and third data sheets respectively showing influence degrees obtained by the factor analysis apparatus and explanatory variable names. In respective items of the first, second and third data sheets illustrated in FIGS. 11, 12, and 13, rank indicates a rank of magnitude of an influence degree, and the influence degree means a regularized coefficient of each explanatory variable obtained by using L1 regularized logistic regression (where the maximum value is “1” and the minimum value is “0”).

The first data sheet illustrated in FIG. 11 shows influence degrees and explanatory variable names when the objective-variable criterion value is “2”. In FIG. 11, a motor rotation speed has the largest influence degree, whose influence degree is “0.41”. Raw material A type ranks the second.

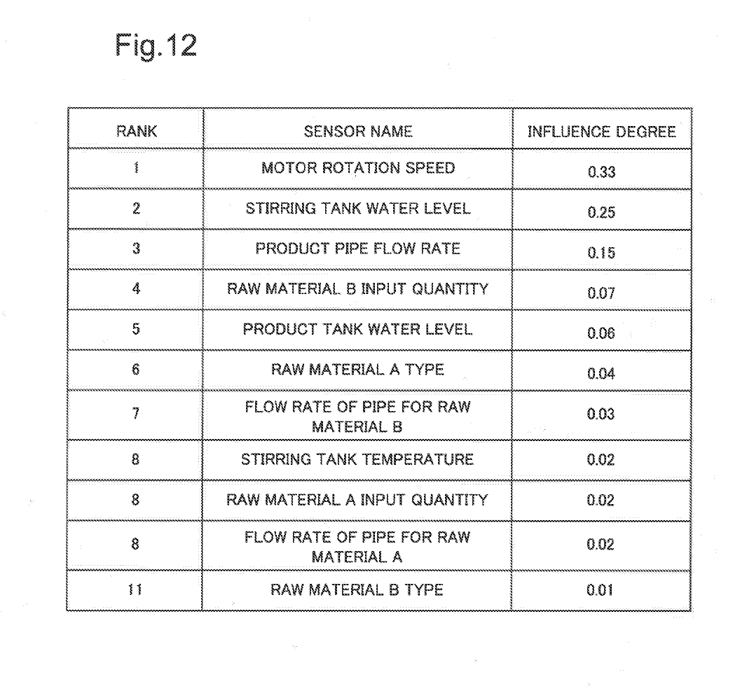

The second data sheet illustrated in FIG. 12 shows influence degrees and explanatory variable names when the objective-variable criterion value is “3”. In FIG. 12, a motor rotation speed has the largest influence degree, whose influence degree is “0.33”, and a stirring tank water level has the next largest influence degree, whose influence degree is “0.25”.

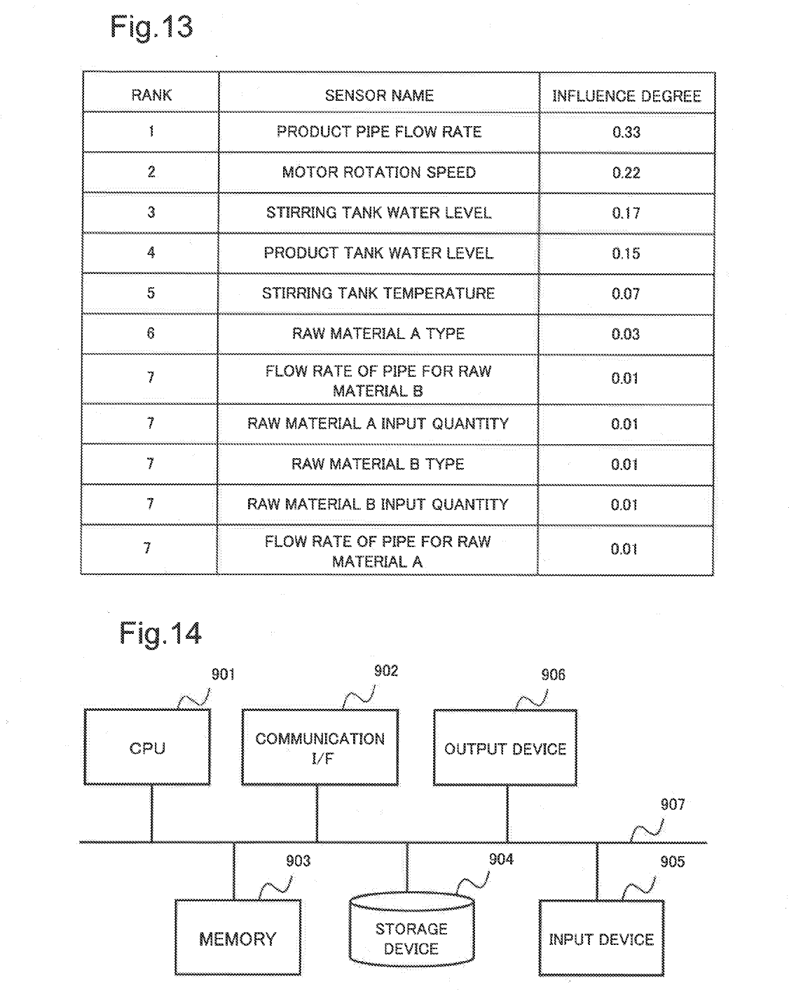

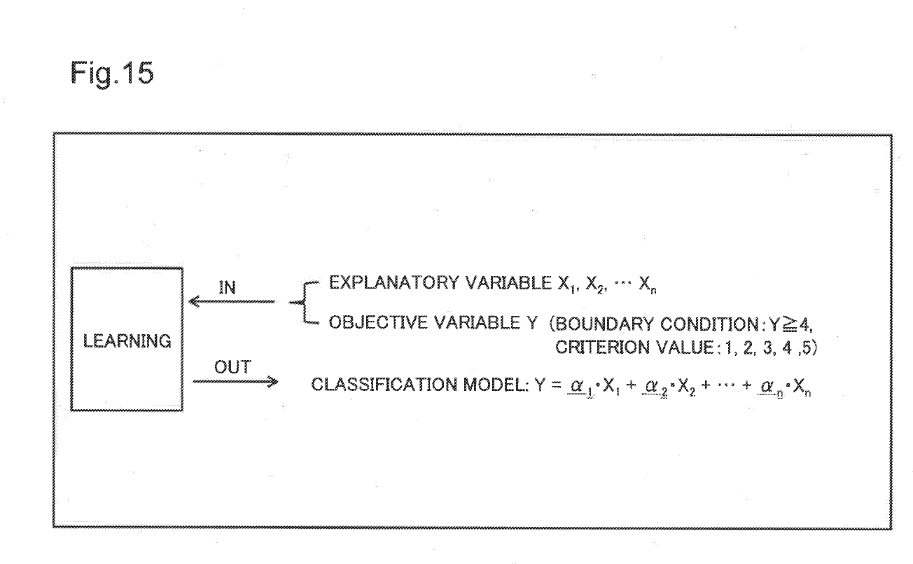

The third data sheet illustrated in FIG. 13 shows influence degrees and explanatory variable names when the objective-variable criterion value is “4”. In FIG. 13, a product pipe flow rate has the largest influence degree, whose influence degree is “0.33”, and a motor rotation speed has the next largest influence degree, whose influence degree is “0.22”. The motor rotation speed and a stirring tank water level rank the second and the third, respectively.

From a result of factor analysis of FIGS. 11 to 13, in this case, the stirring propeller operates irregularly due to an influence of viscosity of raw material A. This makes it possible to predict that a rotation speed of the motor changes, viscosity inside the stirring tank rises and a water level of the stirring tank further rises, and a flow rate of the product pipe decreases with the rise of the viscosity. Accordingly, this allows for stepwisely knowing about what is a factor in advance of final calculation of defective products.

As described above, in the factor analysis apparatus according to the second example embodiment, the influence degree calculation unit 404 learns by using a set of measurement data (objective-variable criterion values) representing manufacturing quality and measurement data (explanatory-variable time-series data) other than the manufacturing quality, and generates a relational expression (classification) given by coefficients α and explanatory variables for each of the objective-variable criterion values. Subsequently, the influence degree calculation unit 104 extracts, from the generated relational expression (classification), a coefficient of the explanatory variable and the explanatory variable corresponding to the coefficient in association with each other. Accordingly, this allows for knowing a fluctuation process of the coefficient for each of the objective-variable criterion values and knowing an explanatory variable that influences an objective variable. This can elucidate transition of a fluctuation factor of the objective variable.

In addition, factors that influence product quality and influence degrees can be narrowed down without determining a boundary condition for the product quality.

The factor analysis system according to the second example embodiment is described by using an example in which measurement data measured by the sensors of the chemical plant are used. However, the second example embodiment is not limited thereto. The second example embodiment is also applicable to an apparatus other than manufacturing as long as the apparatus is capable of obtaining time-series data of an objective variable representing a result of an event and time-series data of an explanatory variable representing a factor of an event. In addition, the second example embodiment is also applicable to a distribution, financial, or traffic system and the like.

### (Hardware Configuration)

FIG. 14 is a diagram illustrating a hardware configuration that implements the factor analysis apparatus according to the first or second example embodiment or the management apparatus according to the second example embodiment by a computer device.

As illustrated in FIG. 14, the functional units of the factor analysis apparatus according to the first or second example embodiment and the control unit 451 of the management apparatus according to the second example embodiment can be implemented by the following hardware configuration. The hardware configuration includes a Central Processing Unit (CPU) 901, a communication interface (communication I/F) for network connection 902, a memory 903, and a storage device 904 such as a hard disk for storing a program. In addition, the CPU 901 is connected with an input device 905 and an output device 906 via a system bus 907.

The CPU 901 controls the functional units of the factor analysis apparatus 101 according to the first example embodiment or the factor analysis apparatus 401 according to the second example embodiment and the management apparatus 450 according to the second example embodiment by running an operating system. In addition, the CPU 901 reads out a program and data to the memory 903 from, for example, a recording medium attached to a drive device.

In addition, the CPU 901 has a function of processing an information signal that is input from the acquisition unit or the like according to each of the example embodiments, and executes processing of various functions, based on a program.

The storage device 904 is, for example, an optical disk, a flexible disk, a magneto-optical disk, an external hard disk, a semiconductor memory or the like. A part of a storage medium of the storage device 904 is a non-volatile storage device where a program is stored. In addition, the program is connected with a communication network. The program may be downloaded from a not-illustrated external computer.

The input device 905 is implemented by, for example, a mouse, a keyboard, a touch panel, or the like and is used in input operation.

The output device 906 is implemented by, for example, a display, and is used for outputting and confirming information or the like processed by the CPU 901.

As described above, each of the example embodiments of the present invention is implemented by the hardware configuration illustrated in FIG. 14. However, the units included in the factor analysis apparatus 101, the factor analysis apparatus 401, or the management apparatus 450 are not limited to particular implementation means. In other words, the factor analysis apparatus 101 or 401 may be implemented by a physically coupled single apparatus, and may be implemented by physically separated two or more apparatuses that are connected wiredly or wirelessly.

In the above, the invention of the present application has been described with reference to the example embodiments (and examples). However, the invention of the present application is not limited to the above example embodiments (and examples). Various modifications that can be understood by those skilled in the art can be made to the configurations and details of the invention of the present application within the scope of the invention of the present application.

A part or whole of the above-described example embodiments can be described as the following Supplementary Notes, but the present invention is not limited to the following.

### (Supplementary Note 1)

A factor analysis apparatus including:

acquisition unit that acquires, from factor analysis data, time-series data of an objective variable representing a result of an event and time-series data of an explanatory variable representing a factor of an event;

criterion-value setting unit that sets, based on the time-series data of the objective variable, a plurality of objective-variable criterion values;

influence degree calculation unit that learns the set plurality of objective-variable criterion values and the acquired time-series data of the explanatory variable, generates a relational expression between the objective-variable criterion value and the explanatory variable for each of the objective-variable criterion values, and extracts, from the generated relational expression, a coefficient of the explanatory variable and the explanatory variable corresponding to the coefficient; and

output unit that outputs the extracted coefficient as an influence degree, and outputs an explanatory variable name associated with the extracted explanatory variable.

### (Supplementary Note 2)

The factor analysis apparatus according to Supplementary Note 1, wherein

the acquisition unit

stores the acquired time-series data of the objective variable and the time-series data of the explanatory variable in a storage device, or sends the acquired time-series data of the objective variable and the time-series data of the explanatory variable to the influence degree calculation unit.

### (Supplementary Note 3)

The factor analysis apparatus according to Supplementary Note 1 or 2, wherein

the factor analysis data are measurement data measured by a measuring instrument, and log data generated by an arbitrary system.

### (Supplementary Note 4)

The factor analysis apparatus according to any one of Supplementary Notes 1 to 3, wherein

an approach for use in the learning is either L1 regularized logistic regression, a decision tree, non-linear regression, or multiple regression analysis.

### (Supplementary Note 5)

The factor analysis apparatus according to any one of Supplementary Notes 1 to 4, wherein

the influence degree calculation unit

calculates the influence degree after thinning out the objective-variable criterion values at a predetermined interval, and, before calculating an influence degree of the thinned-out objective-variable criterion value, calculates by eliminating an explanatory variable having a low influence degree from the formerly calculated influence degree of the objective-variable criterion values, or calculates by using only an explanatory variable having a high influence degree.

### (Supplementary Note 6)

The factor analysis apparatus according to any one of Supplementary Notes 1 to 5, wherein

the output unit

outputs, among a combination of the extracted influence degree and an explanatory variable, in order of value of the influence degree, outputs in order of the explanatory variable name, outputs in order of arrangement of the explanatory variable, outputs in order of time of time-series data included in the explanatory variable, or outputs an explanatory variable name that influences a part or all of the objective-variable criterion values.

### (Supplementary Note 7)

The factor analysis apparatus according to any one of Supplementary Notes 1 to 6, further including a storage device connected with the factor analysis apparatus, wherein

the storage device

stores the time-series data of the objective variable or the time-series data of the explanatory variable that are acquired by the acquisition unit.

### (Supplementary Note 8)

The factor analysis apparatus according to any one of Supplementary Notes 1 to 6, further including a storage device connected with the factor analysis apparatus, wherein

the storage device

stores the influence degree and the explanatory variable corresponding to the influence degree that are extracted by the influence degree calculation unit.

### (Supplementary Note 9)

A factor analysis system including:

the factor analysis apparatus according to any one of Supplementary Notes 1 to 7;

a measurement object apparatus that is to be measured by a measuring instrument; and

a management apparatus that collects measurement data measured by the measuring instrument and sends the measurement data as time-series data to the factor analysis apparatus.

### (Supplementary Note 10)

9. A factor analysis method including:

acquiring, from factor analysis data, time-series data of an objective variable representing a result of an event and time-series data of an explanatory variable representing a factor of an event;

setting, based on the time-series data of the objective variable, a plurality of objective-variable criterion values;

learning the set plurality of objective-variable criterion values and the acquired time-series data of the explanatory variable, and generating a relational expression between the objective-variable criterion value and the explanatory variable for each of the objective-variable criterion values;

extracting, from the generated relational expression, a coefficient of the explanatory variable and the explanatory variable corresponding to the coefficient; and

outputting the extracted coefficient as an influence degree, and outputting an explanatory variable name associated with the extracted explanatory variable.

### (Supplementary Note 11)

A recording medium recording a program that causes a computer to execute:

acquiring, from factor analysis data, time-series data of an objective variable representing a result of an event and time-series data of an explanatory variable representing a factor of an event;

setting, based on the time-series data of the objective variable, a plurality of objective-variable criterion values;

learning the set plurality of objective-variable criterion values and the acquired time-series data of the explanatory variable, and generating a relational expression between the objective-variable criterion value and the explanatory variable for each of the objective-variable criterion values;

extracting, from the generated relational expression, a coefficient of the explanatory variable and the explanatory variable corresponding to the coefficient; and

outputting the extracted coefficient as an influence degree, and outputting an explanatory variable name associated with the extracted explanatory variable.

This application is based upon and claims the benefit of priority from Japanese Patent Application No. 2014-234619, filed on Nov. 19, 2014, the disclosure of which is incorporated herein in its entirety.

### REFERENCE SIGNS LIST

101 Factor analysis apparatus
102 Acquisition unit
103 Criterion-value setting unit
104 Influence degree calculation unit
105 Output unit
300 Chemical plant
301 Feeding tank for raw material A
302 Pipe for raw material A
303 Feeding tank for raw material B
304 Pipe for raw material B
305 Stirring tank
306 Stirring propeller
307 Motor
308 Power cord
309 Power supply
310 Pipe for product
311 Product tank
320 Sensor group
400 Factor analysis system
401 Factor analysis apparatus
402 Acquisition unit
403 Criterion-value setting unit
404 Influence degree calculation unit
405 Display unit
501 Storage device
502 Explanatory-variable time-series data
503 Objective-variable time-series data
504 Influence degree transition data
901 CPU
902 Communication interface (communication I/F)
903 Memory
904 Storage device
905 Input device
906 Output device
907 System bus

1. A factor analysis apparatus comprising:
an acquisition unit that acquires, from factor analysis data, time-series data of an objective variable representing a result of an event and time-series data of an explanatory variable representing a factor of an event;
a criterion-value setting unit that sets, based on the time-series data of the objective variable, a plurality of objective-variable criterion values;
an influence degree calculation unit that learns the set plurality of objective-variable criterion values and the acquired time-series data of the explanatory variable, generates a relational expression between the objective-variable criterion value and the explanatory variable for each of the objective-variable criterion values, and extracts, from the generated relational expression, a coefficient of the explanatory variable and the explanatory variable corresponding to the coefficient; and
an output unit that outputs the extracted coefficient as an influence degree, and outputs an explanatory variable name associated with the extracted explanatory variable.

2. The factor analysis apparatus according to claim 1, wherein
the acquisition unit
stores the acquired time-series data of the objective variable and the time-series data of the explanatory variable in a storage device, or sends the acquired time-series data of the objective variable and the time-series data of the explanatory variable to the influence degree calculation unit.

3. The factor analysis apparatus according to claim 1, wherein
the factor analysis data are measurement data measured by a measuring instrument, and log data generated by an arbitrary system.

4. The factor analysis apparatus according to claim 1, wherein
an approach for use in the learning is either L1 regularized logistic regression, a decision tree, non-linear regression, or multiple regression analysis.

5. The factor analysis apparatus according to claim 1, wherein
the influence degree calculation unit
calculates the influence degree after thinning out the objective-variable criterion values at a predetermined interval, and, before calculating an influence degree of the thinned-out objective-variable criterion value, calculates by eliminating an explanatory variable having a low influence degree from the formerly calculated influence degree of the objective-variable criterion values, or calculates by using only an explanatory variable having a high influence degree.

6. The factor analysis apparatus according to claim 1, wherein
the output unit
outputs, among a combination of the extracted influence degree and an explanatory variable, in order of value of the influence degree, outputs in order of the explanatory variable name, outputs in order of arrangement of the explanatory variable, outputs in order of time of time-series data included in the explanatory variable, or outputs an explanatory variable name that influences a part or all of the objective-variable criterion values.

7. The factor analysis apparatus according to claim 1, further comprising a storage device connected with the factor analysis apparatus, wherein
the storage device
stores time-series data of an objective variable or time-series data of an explanatory variable that are acquired by the acquisition unit, or stores the influence degree and the explanatory variable corresponding to the influence degree that are extracted by the influence degree calculation unit.

8. A factor analysis system comprising:
the factor analysis apparatus according to claim 1;
a measurement object apparatus that is to be measured by a measuring instrument; and
a management apparatus that collects measurement data measured by the measuring instrument and sends the measurement data as time-series data to the factor analysis apparatus.

9. A factor analysis method comprising:
acquiring, from factor analysis data, time-series data of an objective variable representing a result of an event and time-series data of an explanatory variable representing a factor of an event;
setting, based on the time-series data of the objective variable, a plurality of objective-variable criterion values;
learning the set plurality of objective-variable criterion values and the acquired time-series data of the explanatory variable, and generating a relational expression between the objective-variable criterion value and the explanatory variable for each of the objective-variable criterion values;
extracting, from the generated relational expression, a coefficient of the explanatory variable and the explanatory variable corresponding to the coefficient; and
outputting the extracted coefficient as an influence degree, and outputting an explanatory variable name associated with the extracted explanatory variable.

10. A non-transitory computer-readable recording medium recording a program that causes a computer to execute:
acquiring, from factor analysis data, time-series data of an objective variable representing a result of an event and time-series data of an explanatory variable representing a factor of an event;
setting, based on the time-series data of the objective variable, a plurality of objective-variable criterion values;
learning the set plurality of objective-variable criterion values and the acquired time-series data of the explanatory variable, and generating a relational expression between the objective-variable criterion value and the explanatory variable for each of the objective-variable criterion values;
extracting, from the generated relational expression, a coefficient of the explanatory variable and the explanatory variable corresponding to the coefficient; and
outputting the extracted coefficient as an influence degree, and outputting an explanatory variable name associated with the extracted explanatory variable.
